(19) United States
(12) Patent Application Publication
(10) Pub. No.: US 2008/0022824 A1
(43) Pub. Date: Jan. 31, 2008

(54) FENCE MOUNTING STRUCTURE FOR CIRCULAR SAW

(76) Inventor: Chin-Chin Chang, Taichung (TW)

Correspondence Address: G.LINK., LTD, 3550 BELL ROAD, MINOOKA, IL, 60447, US

(21) Appl. No.: 11/460,628

(22) Filed: Jul. 28, 2006

(51) Int. Cl. B23D 19/00; B27B 27/06

(52) U.S. Cl. 83/471; 83/471.3; 83/581

(57) ABSTRACT

A fence mounting structure for circular saw, which includes a main fence, which is affixed to the base plate of the circular saw, a supplementary fence, which has a bottom rail inserted into a sliding groove in the main fence and a locating flange supported on the top side of the main fence, a holding down screw vertically fastened to the main fence and fastened tight to give a downward pressure to the locating flange of the supplementary fence after adjustment of the supplementary fence relative to the main fence, and a tightening up screw horizontally fastened to the main fence and fastened tight to give a forward pressure to a locating groove at the bottom rail of the supplementary fence in horizontal direction after adjustment of the supplementary fence relative to the main fence.

### BACKGROUND OF THE INVENTION

1. Field of the Invention

The present invention relates to a circular saw and more particularly, to a fence mounting structure, which positively locks the supplementary fence to the main fence after adjustment of the supplementary fence relative to the main fence subject to the size of the workpiece to be cut.

2. Description of the Related Art

A circular saw is cutting machine for woodworking. A regular circular saw comprises a main fence affixed to the base plate thereof, a supplementary fence movably coupled to one end of the main fence, and a screw for locking the supplementary fence to the main fence. This design of circular saw is still not satisfactory in function. When the supplementary fence is extended out of the main fence, the center of gravity of the supplementary fence is changed, i.e., the side of the supplementary fence that is disposed outside the main fence becomes heavier than the side of the supplementary fence that is received inside the main fence, resulting in tilting of the supplementary fence. During operation of the circular saw under this condition, the supplementary fence may vibrate, affecting the cutting accuracy and quality.

Therefore, it is desirable to provide a fence mounting structure for circular saw that eliminates the aforesaid drawback.

### SUMMARY OF THE INVENTION

The present invention has been accomplished under the circumstances in view. It is the main object of the present invention to provide a fence mounting structure for circular saw, which holds down a supplementary fence in a main fence in vertical direction as well as horizontal direction after adjustment of the supplementary fence relative to the main fence subject to the size of the workipiece to be cut, preventing vibration of the fences during working of the circular saw.

To achieve this and other objects of the present invention, the fence mounting structure comprises a base plate, a main fence, a supplementary fence, a tightening up screw, and holding down means.

The main fence is affixed to the top side of the base plate. The main fence has a sliding groove extending to one end thereof and a vertical locating hole disposed at one side of the sliding groove. The supplementary fence has a bottom rail inserted into the sliding groove of the main fence for enabling the supplementary fence to be moved in and out of one end of the main fence, a locating groove formed on and extending along the length of the bottom rail corresponding to the extending direction of the sliding groove, and a locating flange perpendicularly extended from one side thereof and supported on the top side of the main fence. The tightening up screw is fastened to the main fence in horizontal and adapted to engage the locating groove of the supplementary fence and further to lock the supplementary fence to the main fence. The holding down member is mounted in the locating hole of the main fence and adapted to give a downward pressure to the locating flange of the supplementary fence to lock the supplementary fence to the main fence.

### BRIEF DESCRIPTION OF THE DRAWINGS

FIG. 1 is a perspective assembly view of a fence mounting structure according to the present invention.

FIG. 2 is an exploded view of the fence mounting structure according to the present invention.

FIG. 3 is a side view of a part of the present invention showing a loosened status of the holding down member.

FIG. 4 is a sectional side view in an enlarged scale of a part of FIG. 3.

FIG. 5 is similar to FIG. 3 but showing the holding down member fastened tight.

FIG. 6 is a sectional side view in an enlarged scale of a part of FIG. 5.

### DETAILED DESCRIPTION OF THE INVENTION

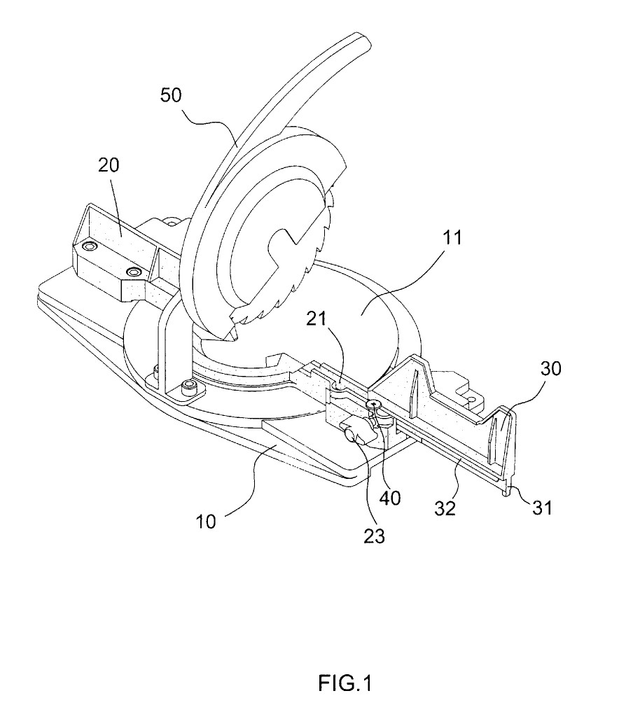

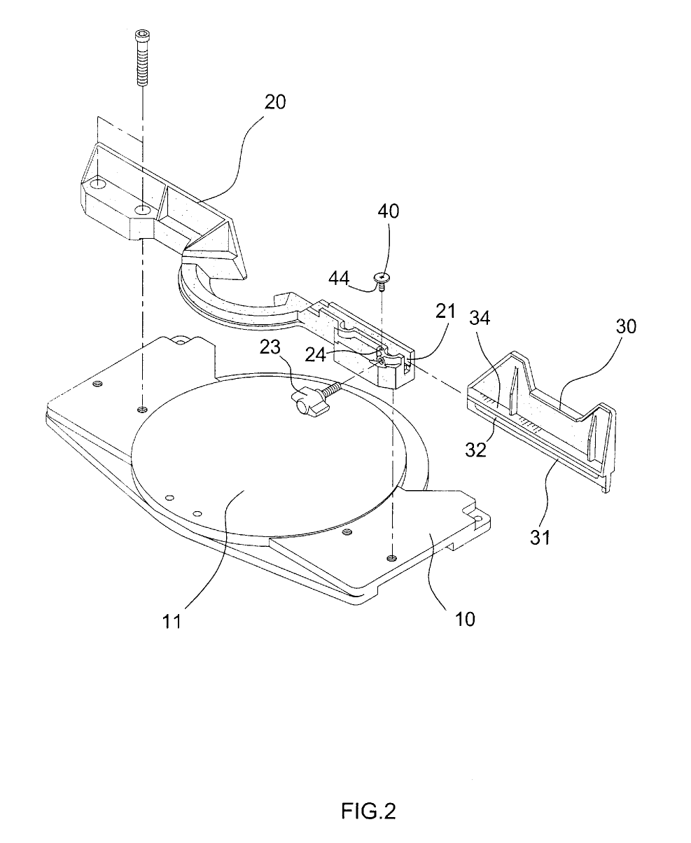

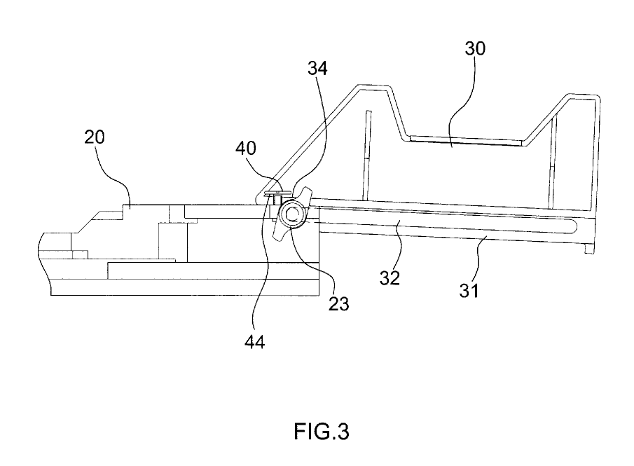

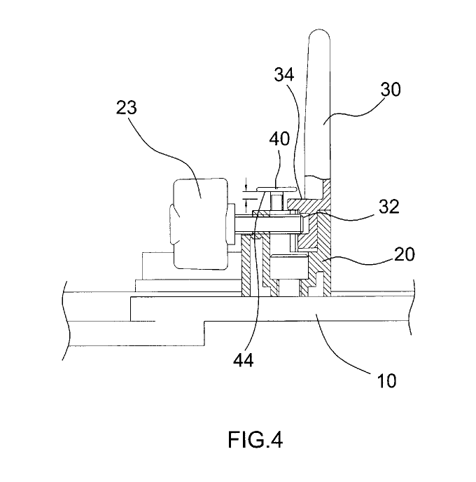

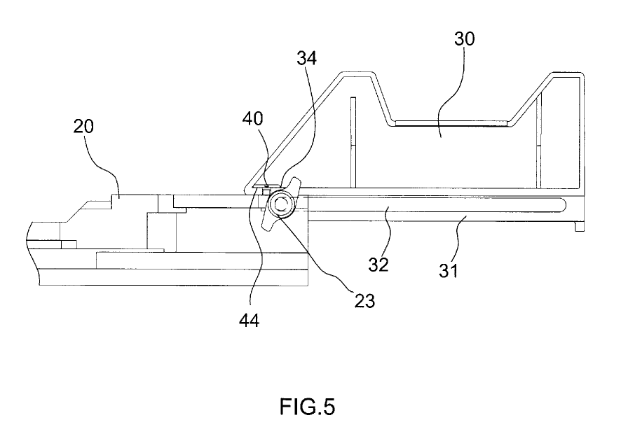

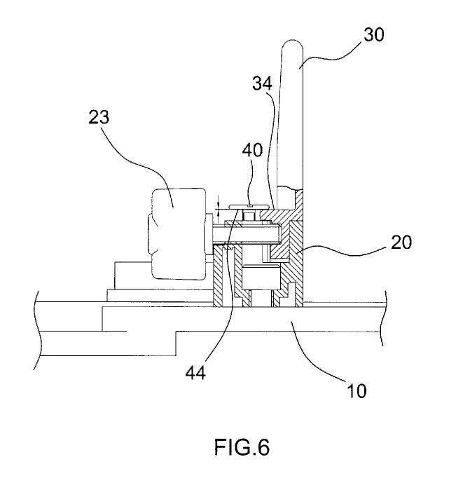

Referring to FIGS. 1-6 a fence mounting structure in accordance with the present invention is shown comprising a base plate 10, a main fence 20, and a supplementary fence 30.

The base plate 10 supports a rotary worktable 11 and a saw unit 50. The rotary worktable 11 is rotatably supported on the top side of the base plate 10. The saw unit 50 is hinged to the rotary worktable 11 at the top side.

The main fence 20 is affixed to the base plate 10 and extending over the rotary worktable 11, having a sliding groove 21 extending to one end thereof along the length for receiving the supplementary fence 30 and a vertical locating hole 24 disposed at one side of the sliding groove 21.

The supplementary fence 30 has a bottom rail 31, which is inserted into the sliding groove 21 of the main fence 20 and movable with the supplementary fence 30 relative to the main fence 20 along the sliding groove 21, a locating groove 32 formed on and extending along the length of the bottom rail 31, and a locating flange 34 perpendicularly extended from one side thereof along the top side of the bottom rail 31 and supported on a part of the top side of the main fence 20.

Further, a tightening up member, for example, a tightening up screw 23 is fastened to the main fence 20 in horizontal, and rotatable forwards/backwards into or away from the locating groove 32 of the supplementary fence 30 to lock/unlock the supplementary fence 30.

Further, a holding down member 40 is mounted in the locating hole 24 of the main fence 20 and adapted to give a downward pressure to the locating flange 34 of the supplementary fence 30 to lock the supplementary fence 30 to the main fence 20. The holding down member 40 can be a holding down plate or flat-head holding down screw. According to the present preferred embodiment, the locating hole 24 is a screw hole, and the holding down member 40 is a flat-head holding down screw threaded into the locating hole 24. The flat-head holding down member 40 has a head 44 that is partially pressed on the top surface of the locating flange 34 of the supplementary fence 30 when the holding down member 40 is fastened tight.

When cutting a long workpiece, the tightening up screw 23 and the holding down member 40 are loosened, and then the supplementary fence 30 is moved outwards from the main fence 20 to adjust the combined length of the main fence 20 and the supplementary fence 30 subject to the size of the workpiece, and then the tightening up screw 23 is fastened tight and firmly stopped against the bottom surface of the locating groove 32 of the supplementary fence 30, and then the holding down member 40 is fastened tight, keeping the head 44 firmly stopped at the top side of the locating flange 34 of the supplementary fence 30. After installation, the tightening up screw 23 gives a pressure to the supplementary fence 30 against the main fence 20 in horizontal direction and the holding down member 40 gives a pressure to the supplementary fence 30 against the main fence 20 in vertical direction, and therefore the supplementary fence 30 is locked to the main fence 20 in the desired position.

A prototype of fence mounting structure for circular saw has been constructed with the features of FIGS. 16. The fence mounting structure for circular saw functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A fence mounting structure comprising:
a base plate;
a main fence affixed to a top side of said base plate, said main fence having a sliding groove extending to one end thereof and a vertical locating hole disposed at one side of said sliding groove;
a supplementary fence, said supplementary fence having a bottom rail inserted into said sliding groove of said main fence for enabling said supplementary fence to be moved in and out of one end of said main fence, a locating groove formed on and extending along the length of said bottom rail corresponding to the extending direction of said sliding groove, and a locating flange perpendicularly extended from one side thereof and supported on a top side of said main fence;
a tightening up screw fastened to said main fence in horizontal and adapted to engage the locating groove of said supplementary fence and to further to lock said supplementary fence to said main fence; and
a holding down member mounted in said locating hole of said main fence and adapted to give a downward pressure to said locating flange of said supplementary fence to lock said supplementary fence to said main fence.

2. The fence mounting structure as claimed in claim 1, wherein said base plate supports a rotary worktable on a top side thereof beneath said main fence, said rotary worktable having hinged thereto a saw unit.

3. The fence mounting structure as claimed in claim 1, wherein said tightening up screw fastened to said main fence in horizontal and rotatable into said sliding groove of said main fence and into engagement with the locating groove of said supplementary fence to lock said supplementary fence to said main fence.

4. The fence mounting structure as claimed in claim 1, wherein said locating hole of said main fence is a screw hole; said holding down member is a holding down screw threaded into said locating hole and adapted to give a downward pressure to the locating flange of said supplementary fence against said main fence.

5. The fence mounting structure as claimed in claim 4, wherein said holding down member has a head, which is pressed on said locating flange of said supplementary fence to give a downward pressure to said locating flange of said supplementary fence against said main fence when said holding down member is fastened tight.
